(19) United States
(12) Patent Application Publication
(10) Pub. No.: US 2018/0276269 A1
(43) Pub. Date: Sep. 27, 2018

(54) TRANSACTION PROCESSING IN DISTRIBUTED DATABASE MANAGEMENT SYSTEM

(71) Applicant: CLUSTERPOINT GROUP LIMITED, London (GB)

(72) Inventors: Zigmars RASSCEVSKIS, Riga (LV); Janis SERMULINS, Riga (LV)

(21) Appl. No.: 15/541,698

(22) PCT Filed: Jan. 27, 2016
(86) PCT No.: PCT/IB2016/000103

§ 371 Date: Jul. 5, 2017

Related U.S. Application Data
(60) Provisional application No. 62/108,277, filed on Jan. 27, 2015.

(51) Int. Cl. G06F 17/30

(52) U.S. Cl. CPC G06F 17/30377; G06F 17/30368; G06F 17/30578

(57) ABSTRACT

Systems and methods here include computerized handling of database transactions that can be employed on distributed architecture without requiring a single point of synchronization. Thus, examples can be embodied by a combination of algorithms that can be implemented in software and hardware allowing distributed deployment on the software. Such systems may be used for updating several documents within a single transaction which may provide, for example, atomicity, consistency, isolation and/or durability of such transactions. This may be accomplished by ensuring a distributed consensus within any of various database nodes, while requiring only a majority of nodes handling each individual shards to be available for transactions to complete successfully.

### CROSS REFERENCE TO RELATED CASES

This application is a National Stage Entry of International Application No. PCT/IB2016/000103, filed 27 Jan. 2016, which is related to and claims priority from U.S. Provisional Application No. 62/108,277 filed 27 Jan. 2015, the content of which is hereby incorporated by reference herein in its entirety.

### TECHNICAL FIELD

This application relates to the field of computerized database management, networked systems and searching, retrieval and analysis of data.

### BACKGROUND

Distributed database management can lack particulars which can allow for robust and efficient transaction processing.

### SUMMARY

In summary, certain examples described here present systems and methods of handling database transactions that can be employed on distributed architecture without requiring a single point of synchronization. Thus, examples can be embodied by a combination of algorithms that can be implemented in software and hardware allowing distributed deployment on the software. Such systems may be used for updating several documents within a single transaction which may provide, for example, atomicity, consistency, isolation and/or durability of such transactions. This may be accomplished by ensuring a distributed consensus within any of various database nodes, while requiring only a majority of nodes handling each individual shards to be available for transactions to complete successfully.

The specifics of ensuring distributed consensus may be based on for example, 1) requiring shards to be versioned in a way that can allow increasing its version with only some of nodes responsible for the shards being available; 2) creation of the transaction log (discussed below) as a sequence of records, where each of them corresponds to a transaction executed against the database and specifies the minimum version of every shard necessary to reflect all operations within the transaction; 3) requiring transaction log as well to be versioned in a way that allows increasing version with only some of the nodes responsible for the transaction log being available; and/or 4) when answering a request from a client to the database, establishing a required transaction log version and passing that transaction log version along with the requests being sent from hubs to nodes.

Some embodiments include non-transitory computer-readable storage media, systems and/or methods to store one or more data shards of document repositories, by a hub in communication with a plurality of storage nodes, receive, by the hub, a data document for storage, identify by the hub, a data shard to store the document, identify by the hub, the nodes where replicas of the identified data shard are stored, send by the hub, the document to one of the identified nodes which has stored the identified data shard, receive by the hub, a document identifier from the node for the sent document, wherein the document identifier number includes an indicator of the node which stores the identified data shard and a sequential number representing the next sequential number of documents stored in that identified data shard, send by the hub, the document to the identified nodes where the replicas of the identified data shard are stored, including the document identifier for the document.

In some embodiments, the received document identifier also includes an identified data shard indicator. In some embodiments, the shard replicas retain the document identifier of the received document to indicate which documents are stored in the shard replica. In some embodiments, the document identifier of the received document is combined with previously received documents to indicate which documents are stored in the shard replica. In some embodiments, the hub includes a transaction log which stores information for each transaction, a transaction identifier, a committed status of the transaction and a multi-dimensional shard identifier indicating the documents needed to complete the transaction. In some embodiments, a client in communication with the hub, the client may be configured to send the hub a document. In some embodiments, another hub may be in communication with the plurality of storage nodes. In some embodiments, documents received by the node out of sequence are stored in a back log. In some embodiments, documents placed in the back log are later stored if any missing sequential documents are received, and in some embodiments, the document identifier is updated when the missing sequential documents are received and stored along with the documents placed in the back log.

Non-transitory computer readable media, methods and systems here include database management using a server running a distributed architecture of database hubs and nodes, the server configured to, receive a data document for storage, send the data document to the hub for storage, the hubs configured to, receive document for storage, identify a shard to store the document, identify the nodes which store the identified shard and its shard replicas, select one of the nodes which store the identified shard and its replicas, send the received document to the selected node, receive an acknowledgement from the node that the node has received the document for storage and assigned a document identifier to the document, and send the document and the assigned document identifier to the nodes which store the shard replicas.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an example network diagram which may be used with example embodiments described here.

FIG. 2 is an example diagram showing database management used with example embodiments described here.

FIG. 3 is an example flow chart of certain example method embodiments described here.

FIG. 4 is another example diagram showing database management used with example embodiments described here.

FIG. 5 is an example graph showing aspects of database management used with example embodiments described here.

FIG. 6 is another example diagram showing database management used with example embodiments described here.

FIG. 7 is an example computing device which may be used with or as example embodiments described here.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

Database management in a distributed environment may result in inefficient usage of data storage as well as inefficient management of retrieval and management of that stored data. Redundant storage may safeguard stored data but protection is only useful if a system can access that stored data efficiently. Additionally, ever-increasing volumes of data are now being produced for normal business operations, complicating the storage and retrieval of such.

Managing data stored in such databases may be done using an application programming interface (API). A common database API may expose operations that allow modification of individually stored data items. A transaction within a database may be a group of such operations performed within a database that is treated in a coherent and reliable way independent of other transactions. This group of operations for many use cases and applications may need to be executed simultaneously or nearly simultaneously.

In some situations, transactions may provide an all-or-nothing proposition, where each operation performed in the context of the overall transaction must either complete in its entirety or have no effect on the database whatsoever. Such an arrangement may aid in recovery from failures and may keep the database more consistent.

In some examples, the database system may isolate each transaction from other transactions. In situations where programs access the database concurrently, the database system may guarantee that data accessed within any particular transaction does not see results of operations partially applied form another transaction.

In some systems, ensuring transactional integrity may be maintained by a single point of synchronization that every transaction accesses. However the existence of a single point of synchronization may limit the performance and fault tolerance of the database system as a whole.

As a result the examples here allow a technical result of handling database transactions in a scalable way with fewer performance barriers. More transactions per second may be handled by a hardware deployment in a distributed way, when new servers are added to the deployment.

Example Network

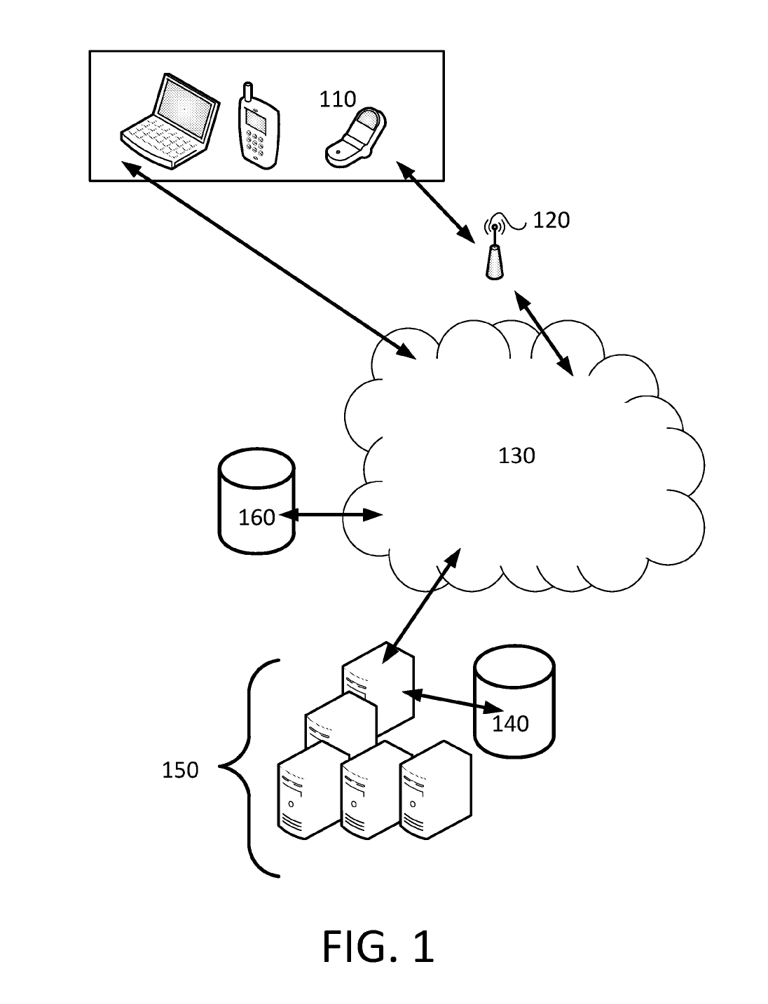

FIG. 1 shows an example network diagram depicting any of various devices 110 running applications which are connected to a network 130 such as the Internet by land line or wireless 120 connections. Such client devices could be used to interact with any of various database management system computers 150. In such an example, the system computers 150 are also shown in communication with the network 130 and also to internal storage in the server itself 150, a local data storage 140 and/or a cloud based storage 160. Any of various configurations of database storage could be used, remote, distributed, local or combinations, with the examples shown in FIG. 1 as exemplary and not limiting.

Certain examples may include a combination of distributed database software that is run on a hardware deployment comprised of any number of servers. In an example hardware deployment, as in FIG. 1, many servers 150 may be used that are similar in terms of components and thus computational resources available to each server and connected using a computer network. The servers 150 may be composed of any kind of parts used in an off-the-shelf consumer computer market that allow deployment to be cost effective. In such an arrangement, a failure of an individual server would not prevent overall operation of the database, thus providing high-availability for overall system even with high failure rate of individual components.

In certain examples, the database management software is run on every server 150 in the deployment. A database software may be composed of two processes: nodes that persist and operate data and hubs that receive requests from a client, distribute requests to nodes, aggregate results and return aggregated results back to a requesting client. Such distributed database system comprised of nodes and hubs may allow data to be divided among and managed by many servers 150 in parallel, but present to client as a single database hiding the distribution arrangement.

In such a way, the servers may run particularized software that increase the efficiencies of data storage and data retrieval. The user interfaces for such interactions with the database may streamline and make efficiencies by automating certain data storage decisions such as storage location, replication numbers and assignment of identifiers for such. The multi-dimensionality of the identification and storage systems may make tracking and retrieval of document storage easier. Additionally, such an arrangement may allow for storage scalability, adding nodes and hubs to accommodate increases or decreases in data storage needs, while de-centralizing the synchronization of data storage, repair and replication.

While we describe the implementation comprising of hubs and nodes this is only exemplary. Many different implementations are possible since it is possible for a hub to perform some or all of the functions of the node and for the node to perform some or all of the functions of the hub. Also it may be possible to distribute the functionality of the hub or node among several independent processes. Also it is possible that some of the functionality of the hub may be moved to the client of the database.

Document Oriented Storage

The distributed transaction handling methods described here may work in a document oriented database where data is partitioned in distinct documents each of which may contain hierarchical structure of multiple typed fields. In certain examples, the structure of the documents within the database is not relevant for the operation of transactions and thus does not have to be homogeneous. The document does not have to be textual and could also contain arbitrary binary data.

In certain examples, an entirety of documents stored in a particular database storage may be referred to as a repository. Each repository of documents may be divided into some number of independent storages referred to in this example as shards. Assignment of documents to such shards may be created based on a number computed by a hash function or any other function on some document key. Additionally, one or more such shards may be stored in a node.

In such an examples, the number of shards can be arbitrarily selected based on number of nodes to allow spreading them among physical servers or databases effectively and/or efficiently. By doing so, the database can be arbitrarily scaled by adding more servers to hardware deployment and retaining fixed number of documents per server.

Further, for redundancy and availability, the shard collections of documents may be replicated and stored in any of various nodes. In such examples, the shard replicas are intended to be duplicates of one another, thus, when an update is made to one shard, its replicas require the same update. It is this updating and maintenance of the shard replicas which is described in detail below.

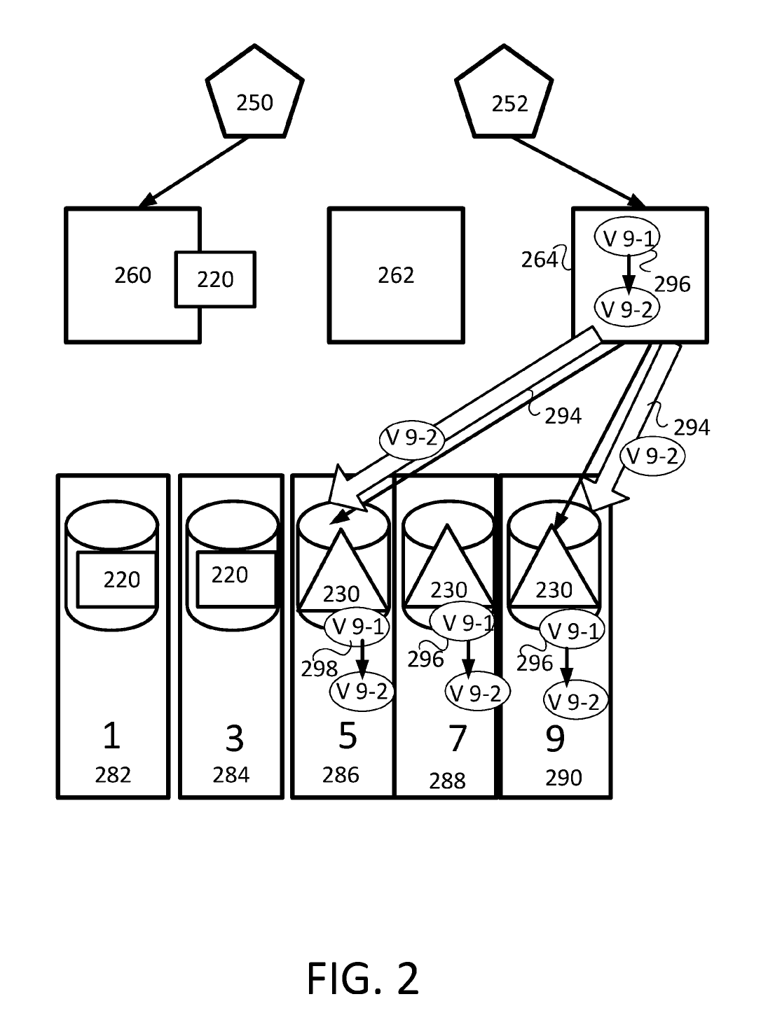

The example of FIG. 2 shows such an example of two clients 250, 252, which may be processes or application implemented and/or run by a database user. In the example, the clients 250, 252 are in communication with any of various multiple hubs 260, 262, 264. The hubs, in turn, are in communication with various nodes labeled in this example “node 1” 282, “node 3” 284, “node 5” 286, “node 7” 288, and “node 9” 290. Such a structure of hubs and nodes may be a construct of the server and the functionality of the hubs and nodes could be combined, separated, or arranged in different ways. The examples here of hubs and nodes are merely exemplary in order to explain the basic functionality of the systems.

It should also be noted that any number of clients, hubs and nodes as well as documents and shards may be used in any given system and the numbers used here are for exemplary and non-limiting purposes.

Stored on these nodes, as described above, may be one or more shards of documents. In the example of FIG. 2, there is only one shard stored in each node for simplicity's sake. As will be described later, multiple shards, each with their own identifier, may be stored in any one node. The example of one shard per node is exemplary and not intended to be limiting.

In the example in FIG. 2, documents 296 may be stored by the hubs 260, 262, 264 into any of the various nodes and the shards of documents within those respective nodes. As shards may be replicated and stored for redundancy and availability purposes, the example shows that there are two families of shard replicas, the first shard and its replicas is represented by a rectangle 220 and the second shard and its replicas is represented by a triangle 230. Thus, as shards and their replicas are intended to be kept updated with the same data and documents, when an update is sent to one, it is propagated to the others in that related shard family.

Further, in the example of FIG. 2, the first shard document collection family 220 is shown stored in two nodes 282 and 284 and the second shard document collection family 230 is shown stored in three nodes 286, 288 and 290. Thus, each shard document collection is stored on several nodes to provide greater availability through hardware fault tolerance.

The hubs, as later described, may be used to assign documents to nodes and shards for storage. Shards may be labeled to indicate which documents are stored by it, in a shard version.

In summary, certain examples described here present systems and methods of handling database transactions that can be employed on distributed architecture without requiring a single point of synchronization. Thus, examples can be embodied by a combination of algorithms that can be implemented in software and hardware allowing distributed deployment on the software. Such systems may be used for updating several documents within a single transaction which may provide, for example, atomicity, consistency, isolation and/or durability of such transactions. This may be accomplished by ensuring a distributed consensus within any of various database nodes, while requiring only a majority of nodes handling each individual shards to be available for transactions to complete successfully.

The specifics of ensuring distributed consensus may be based on for example, 1) requiring shards to be versioned in a way that can allow increasing its version with only some of nodes responsible for the shards being available; 2) creation of the transaction log (discussed below) as a sequence of records, where each of them corresponds to a transaction executed against the database and specifies the minimum version of every shard necessary to reflect all operations within the transaction; 3) requiring transaction log as well to be versioned in a way that allows increasing version with only some of the nodes responsible for the transaction log being available; and 4) when answering a request from a client to the database, establishing a required transaction log version and passing that transaction log version along with the requests being sent from hubs to nodes.

Assignment of Documents and Identifiers

When documents are sent to the hub to be stored in the nodes, the hub must decide in which nodes and which shards to store them. The decision of which shards the hubs use to store the documents may be completed in any of various ways. One example may use a hash function computing a shard number out of a document key. Other example includes a random assignment. The decision of which nodes database system uses to store particular shard may be completed in various ways using a scheduling algorithm.

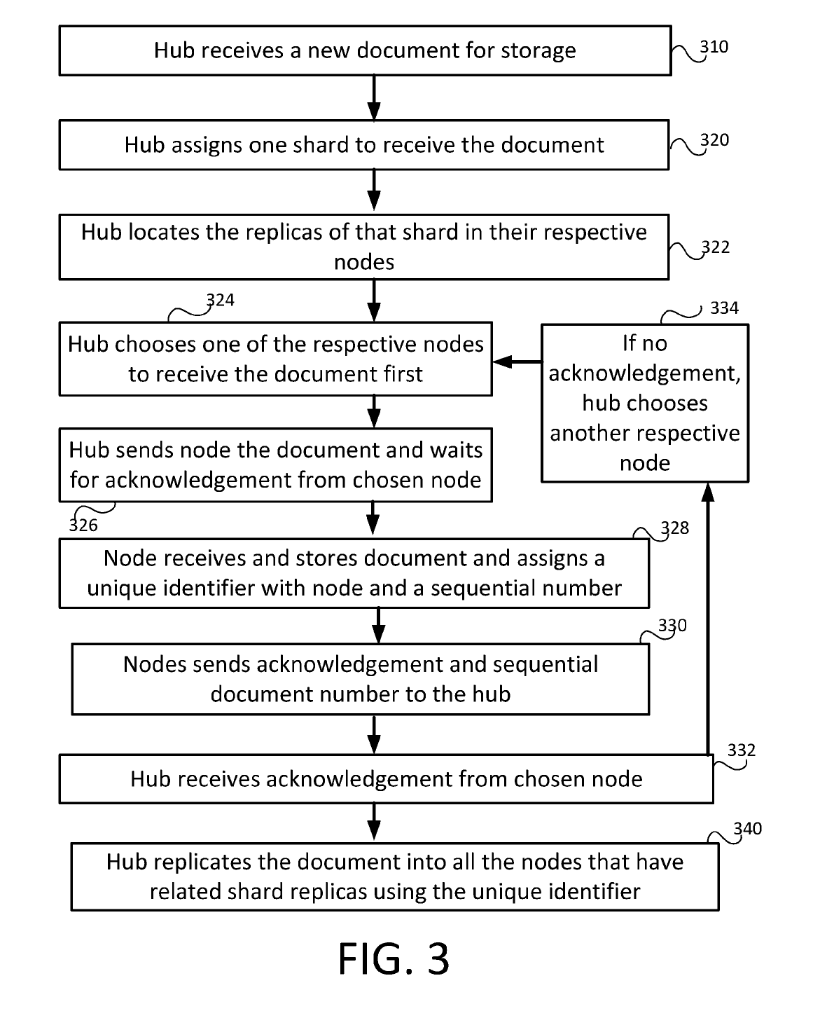

The process of receiving and storing new documents is explained in the flow chart of FIG. 3. In the example of FIG. 3, the hub first receives a new document for storage 310. Then, that hub assigns one of the shards corresponding to the chosen repository as the one to store the document 320. This can be done using any function mapping document keys to shards.

The hub then locates the replicas of that assigned shard stored in their respective nodes 322. After locating the nodes that have stored the selected shard replicas, the hub chooses one of the nodes to first receive the document 324. The hub then sends the document to the chosen node and waits for acknowledgement from that chosen node, that it has received the document 326.

The node receives the document, stores it in the chosen shard and assigns the document a unique identifier corresponding to the node identifier, and the next sequential number of the documents that the node has already stored 328. For example, if that shard is stored in node “6” then it will identify that node in the document identifier. And if that shard in that node has already stored 10 documents, the next document it receives for storage and assignment of an identifier, will receive the node identifier and the number 11 in sequence. Thus, the example document identifier would be 6-11. In examples where the node has more than one stored shard, the shard identifier must also be included so as to ensure that the document identifier is unique.

After receiving the document and assigning a unique document identifier, the node sends an acknowledgement to the hub, along with the assigned document identifier EE30.

The hub receives the acknowledgement from the chosen node EE32.

If the hub does not receive an acknowledgement from the chosen node, the hub chooses another respective node 334.

After successful acknowledgement is received, the hub attempts to replicate that document to every node which includes a shard replica of the chosen shard used to store the document, also receives a copy of the document to store 340. This document will still bear the identifier assigned to it from the first node which was selected to store it, and the sequential number assigned by that node. Thus, a shard in a node may store any number of documents which are labeled with other node identifiers, as described below.

It should be noted that the first number in the document identifier does not have to be the node identifier. It could also be a virtual identifier, which is computed by some one-to-one function or mapping from the node identifier to some virtual identifier. It could also be something like “ShardA_Replica1”, “ShardA_Replica2”, “ShardB_Replica1”, as long as all shard replicas agree on which one is Replica1, Replica2 etc. Also the second number that denotes the number of documents stored by the node can be represented as a result of any one-to-one function from the number of documents stored. For example a one document stored could be represented as 1'000'000'000−1=999'999'999. Two documents stored as 999'999'998 etc.

Multi-Dimensional Shard Version Examples

As discussed above, the data stored in a document based database can be divided into a number of shards of document collections and each shard can be replicated and stored in several copies on any of several nodes. And stored within any particular shard may be any of various documents, each labeled with their own unique identifier as described above.

In order to keep track of which documents are stored in which nodes and shards, a shard version may be used as a short-hand labeling way of understanding which documents are stored in a particular shard. Such a shard version label may reflect which documents it has stored in it, according to the node-sequential document number system as described above. And because such a labeling system allows sequential document to be labeled in order, the shard labeling may be a way to concisely see which documents are on any node and shard at any given time. This is true even if the documents stored in the node and shard were first assigned identifiers by other nodes than the node currently storing it. And as a shard may store documents which were first assigned identifiers by more than one node, the total documents stored by any one node will reflect this multitude of originally identified documents. Such a multitude may be referred to as multi-dimensional.

This can be explained by looking again at FIG. 2. In the beginning, before any documents are stored, each shard replica may have an empty version and contain no documents. In FIG. 2, when a first document 296 comes through a hub 264 for storage, that hub 264 may decide which shard to store the document in. The hub would then identify all of the nodes which have replicas of this shard stored in them. Then the hub would select one of those nodes in which to first send the document. In the example of FIG. 2, the hub 264 identifies all the nodes in which that shard is stored and chooses to first send the document to node “9” 290. In doing so, that first node, here node 9, receives the document and assigns the document a document identifier number “9-1” 296. This document identifier of “9-1” is labeled this way because the first node to acknowledge storing the document 230 assigns the identifier so as to uniquely label it, in this case, node 9, 290. The second number in the identifier is the sequential document number for the total number of documents to which the node has assigned a unique identifier or labeled so far. In this example, because node 9 previously had not labeled any documents of the particular shard, the sequential number is a “1.” So, this first document receives a document identifier 9-1. If this document had been the second document first labeled by node 9, it would have been 9-2, etc.

Such an example is also described in FIG. 3 above. In such examples, if a node includes more than one shard, then a unique shard identifier may also be appended as well. For example, although not pictured, if node 9 in FIG. 2 included both an A and B shard, the new document may be labeled 9-1-A if it is the first document of the shard A labeled by the node 9. This could again be used by any number of nodes, shards, etc. but the example here is one shard for one node for simplicity sake only.

Back to the example of FIG. 2, when the hub stores the first document to node 9 which assigns the document identifier 9-1, the hub 264 also sends for storage the document with the unique identifier, in this example, “9-1” to all the other nodes which are replicas of the shard in node 9. In the example FIG. 2, this is the triangle shard 230. So, in this example, because nodes 5 and 7 also include the same triangle 230, they will also receive the document labeled 9-1 so that the triangle shard replicas 230 are consistent. The document labeled 9-1 is not sent to the nodes that are storing the other shard, in this example the rectangle shard 220, because the hub has selected the other shard and its replicas for whatever reason.

In such a way, each document that comes into the system for storage is thus assigned a unique document identifier according to the first node it is stored in, and then replicated to all the shard replicas that the system has distributed to various nodes.

When another new document comes into the system, whether that document is an update of a previous document, a new document, or something else, the system may do the same thing: assign the document to a shard for storage, assign a document identifier according to the node and shard it is first saved in, and replicate that document, with unique document identifier to the other shard replicas stored in other nodes. Thus, in the example, the second document that is assigned by the hub 264 to node 9 for storage will receive document identifier 9-2. And then, for that new document, 294 the hub replicates that document along with the document identifier 9-2 to the other nodes which also contain that particular shard 230, in this case node 5, 286 and also node 7, 288, just as it did for the first document.

If the hub decided to send the third document (not pictured) to node 7 for storing and labeling first, such a document would receive identifier 7-1 as it would be the first document first labeled by node 7. Then the hub would replicate that document, with identifier 7-1 to nodes 5, 286 and node 9, 290 because they also have the same shard, the triangle shard 230 stored there.

This would result in the shard and its replicas containing three documents: 7-1, 9-1 and 9-2. In order to easily show that these three documents are all stored in this shard, without having to list all the documents, the system may show a shard version of 7-1.9-2 indicating that the three documents are all stored and implying that 9-1 is stored even without listing it separately, because it is assumed that all previous sequentially labeled documents are present in that shard.

Such a storage naming convention may be referred to as multi-dimensional, where the dimensions are the multiple document identifiers which were first assigned the number by a particular node, making a shard version. A multi-dimensional shard version of 7-1.9-2 has two dimensions. Another example of 3-5.7-14.9-2 has three dimensions.

More Multiple Dimension Examples

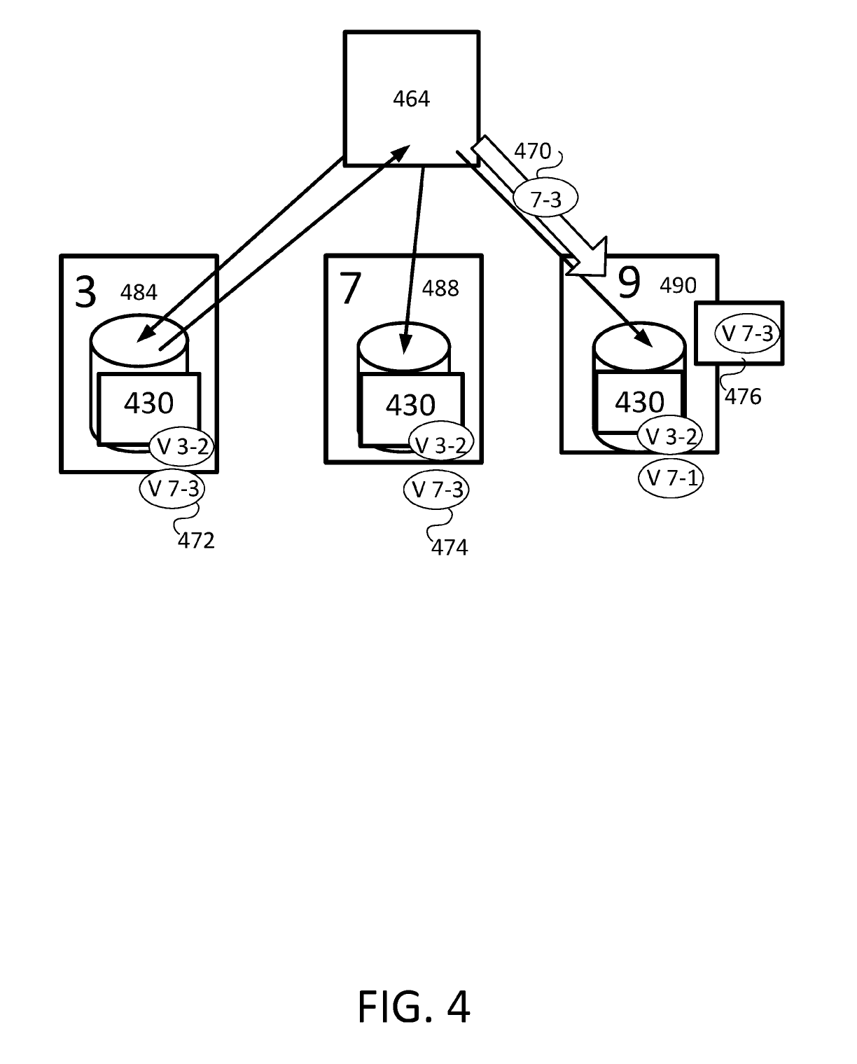

Thus, as discussed briefly above, a hub may assign different documents from the same shard first to different nodes, and also updates the nodes that have replicas of the shard, so each shard replica could accumulate many multiple documents with versions that would reflect these labels. As an example, a set of documents in a given shard could be labeled with a shard version: 7-4.9-2. In such a case, the shard version indicates that this particular shard replica has received six documents: 7-1 then 7-2 then 7-3 then 7-4 and also 9-1 and 9-2. These documents may not have been received in this order, in fact, using the backlog example described above and in FIG. 4 below, these documents could have arrived at this example shard in any order, and could have used the backlog to put them in the correct order for completeness.

In another example, and continuing with the FIG. 2 example, a shard in node 5, 286 already has an updated document 9-2. But another document in that shard may receive an update, for example one labeled 7-1 and then update to 7-2 and then update to 7-3, all of which are propagated to the shard 230 stored in node 5, 286. In such an example, the shard would have a version which could indicate that it is storing five documents: 7-3.9-2 because it has received the three updates to the first document and two updates for the second document.

In such examples, the numbering may be referred to as a shard version. Such a shard version would indicate the documents received by any particular shard, replica as long as the documents are in the correct order. A node with a shard replica may therefore have actually received many more documents than are indicated in the shard version number, but because they are out of order, they are not reflected in the version number.

For example, if a shard receives documents 9-1 then 9-2 then 8-1 then 8-5 it has received four documents. However, its shard version will only be 8-1.9-2 because 8-5 is out of order.

And because any number of shard replicas may not be up to date at any given moment, even though shard replicas are intended by the system to contain all the same data, the only way to check this would be to analyze its shard version to see which documents it has received in the correct sequential order.

It should be noted that any kind of version counter or indicator could be used. The examples in FIG. 2 is merely exemplary. The examples could be 7-1001 for a version number consisting of the unique node identifier “7” and unique version number “1001” so as to uniquely identify the document version among the shard replicas.

Backlog Examples

In order to avoid a situation where one missing document delays the system for too long, a backlog may be used by a node to store out-of-order documents, so that when the missing document(s) are received, all of the previous out-of-order but received documents may be properly stored, and the shard version updated. Without a backlog, a node may discard out-of-order documents, waiting for the next sequential document, but once that next sequential document arrives, the shard version may only be incremented by one. If in the interim of waiting for a particular missing document in sequence, many multiple other out-of-order documents are stored in a backlog, when that one missing document is finally received, the shard version may leap many multiple numbers, reflecting the backlogged documents being integrated into the main permanent storage as well, allowing access and availability of the entirety of the received documents.

An example of this is shown in FIG. 4. In the example of FIG. 4, one shard is replicated in three nodes: node 3, 484, node 7, 488 and node 9, 490. Thus, the hub or the nodes themselves or any other repair process is attempting to make sure that all of the shard replicas in each of the three nodes contain all of the same documents.

In this example, because the first document was first stored in node 3, it received a “3-1” document identifier. There was also a second document stored in node 3 so it received a 3-2. Another document was first stored in node 7 so it received a 7-1 and a second in node 7 first so it received a 7-2 and even a third was stored in node 7 first so it received a 7-3.

But in the example, while attempting to propagate the documents so that the shard replicas all contained the same documents, the hub 464 has missed one document, or the document failed to reach node 9 for some reason. In the example, the shard 430 in node 3 is up-to-date, it has shard version 3-2.7-3. And the same is true with node 7 488. But node 9 490 has only received 3-1 and 3-2 along with 7-1. It has not received document 7-2. Thus, when the hub 464 sends the shard replica 430 in node 9 the document with identifier 7-3, 470, the node is not able to store it and update its own shard version number. Instead, the node stores document 7-3 in a backlog 476 for later access.

Unless and until the node 9 490 receives document 7-2 to store in its shard, it will not update its shard version in case it receives any other documents first stored in the node 7, unless it receives a document 7-2. If the node 9 490 would receive a document 3-3 it could store it in the permanent storage and update its shard version accordingly, because that increments its shard version by exactly one in one of the dimensions. However, a document 7-3 would increase the shard version by more than one so it is put into backlog, until document 7-2 arrives. Once document 7-2 arrives it is stored into permanent storage along with document 7-3 and the shard version is updated accordingly to reflect the storage of both documents.

Thus, it is incumbent for the system to synchronize by checking for missing documents and attempting to fill in the missing documents in any given shard to ensure they are as up-to-date as possible. The system may be able to synchronize and update itself in any of various ways. In certain examples, the hub 464 checks for updates. For example, a hub may fetch versions 7-4, 7-5, 7-6, and 7-7 and store them onto a shard replica which was showing 7-3.8-1. Such an update would progress the shard to version 7-7.8-1.

In some examples, the nodes are able to check for updates themselves. In some examples, there are periodic updates. Any of various ways may be used to update the shards and shard replicas which are stored in the nodes.

In the example, the node 3, 484 is shown communicating back and forth with the hub 464. This is because once the node has assigned the unique identifier to the document, it must inform the hub, so the hub may propagate the document to other replicas along with the identifier.

If, in certain examples, the hub doesn't receive the identifier indicator from the first node it attempts to use, the hub could go to another node for assignment of identification. Then the hub would use the identifier that it receives acknowledgement.

Tracking Multiple Dimensions

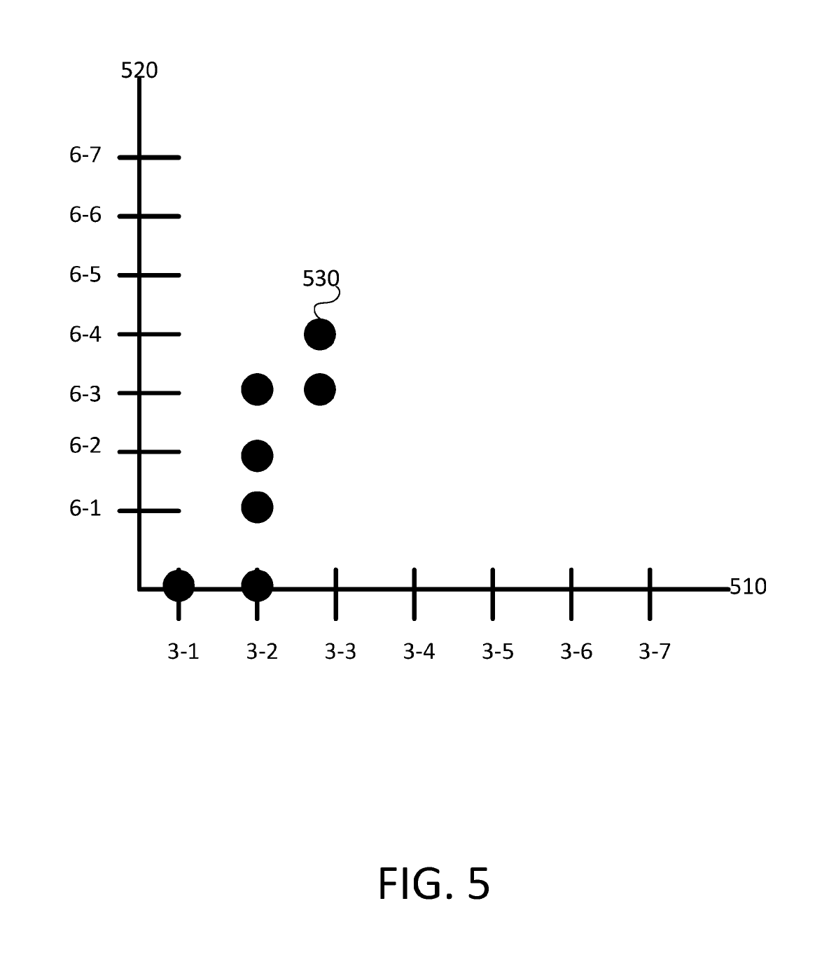

One way to help visualize the dimensions of shard replica updates is to use a graph. An example is shown in FIG. 5. In FIG. 5, a particular shard replica and its stored documents are represented. Because in the example of FIG. 5, there are only two nodes that have replicas for this shard (node 3 and node 6), this shard replica may be referred to as a two-dimensional shard replica. In the graph, one of the nodes is represented on each of the two axes because this is a two dimensional shard replica. In this example, node 3 is represented by the “X” axis 510 and node 6 is represented by the “Y” axis 520. To keep track of the updates and proper number of documents in this particular shard replica, the system may track the document identifiers, represented in FIG. 5 in the two dimensional graph.

It should be noted that a two dimensional example is not intended to be limiting but merely exemplary. Any multiple dimensions may be kept track of in this way, depending on how the hubs originally labeled the documents which are now stored in this particular shard. In some examples, three, four, five and/or more number of dimensions may be kept track of in this way.

Continuing with the example in FIG. 5, the system is able to track for this particular shard replica which documents the node has received in a sequential and contiguous fashion. Again, as described above, the shard version is only updated when a document with an identifier that would increase the shard version by exactly one in one of the dimensions is stored permanently. No backlogged documents may be reflected in this shard version.

Here, in this example, the shard replica has received documents 3-1, 3-2 and 3-3 as well as documents 6-1, 6-2, 6-3 and 6-4. The order that the documents were received in this shard node may be extracted from the way that the graph is arranged. The dot 530 in the graph example keeps track of the documents received by incrementing on the respective axis as the document arrives and is stored.

In this example, the first document was 3-1 and then 3-2 and then 6-1 and then 6-2 and then 6-3 and then 3-3 and then 6-4. In the example of FIG. 5, the ultimate shard version is 3-3.6-4 represented by the last dot 530 in the graph.

If, in a certain example, the shard replica received an out of order document, the node would place that document in a backlog as described above, and then only update the shard replica version when the intervening and complete listing of documents is received and stored. In the example of FIG. 5 the stored documents are in order.

In certain examples, all of the received documents are represented by the graph, even if they include documents which are not sequential. In such examples, the system may be able to then retrieve the identifiers of the missing documents, and fetch them through the hub or other ways.

Document Key Examples

In certain cases a document key may be required when adding or modifying data or documents from the repository. Such a key may be passed by a database client separately from the document or may be extracted from the document or data given some set of rules. The document key can be any alphanumeric string of letters and/or numbers and some special characters. They key may not need to be used for determining storage in all examples. For instance, the system could randomly assign shards for storing documents, or users could specify the shard explicitly, but in certain examples the document key may be used in conjunction with a hash or some other function as described here to determine the shard. Thus, in such examples, a user may not need to decide in which shard any particular document is stored.

In such an example the document key can also be used when retrieving or deleting particular documents. Also the system might enforce that there can only be one document for a given key at any point in time as any update to the same key effectively overwrites the original document and any attempt to add another document with the same key might be rejected by the system.

Transactions and Operation ID Examples

In certain examples, a number of operations may be grouped and referred to as a transaction. Such an operation may be a read, a modification, an addition of a document or retrieval of all documents matching a particular condition within the database system. In such an example, the client first contacts one of the hubs to create a new transaction and receives a special transaction token that it has to pass to the hub when performing any operation that is part of the transaction. Once the client has successfully completed the desired operations it should ask the hub to commit the transaction and make the results permanent and visible to other transactions. Also at any point the client can ask the hub to abort the transaction. The transaction may be aborted by the hub in some error cases automatically.

The hub creates a separate transaction context for each transaction that stores the data needed for performing the operations within the transaction. This is called the transaction context and is discussed later. This information may be shared among several hubs, or else all operations concerning a given transaction need to go through a single hub.

Transactions, which may include many operations, may receive a flag of “committed” when all of the operations in a given transaction have been performed. Transactions may receive a flag of “uncommitted” before all of the operations in that transaction have been completed. Transactions results may not actually be seen by other clients and transactions until they are labeled as committed to keep the system from accessing partially operated documents. However, any operation within the transaction is guaranteed to see the data it has created or modified, this is achieved by storing and updating the required shard versions in the transaction context.

To guarantee transactional consistency, a database system may ensure that a replica queried by a user has received all the updates made within the transaction. Also, if several documents are updated in a single transaction and they end up in distinct shards, then a database system should ensure that all consecutive accesses to the database involving replicas of those shards return consistent versions both including or both excluding updates corresponding to a particular transaction. In order to ensure that the system sees all multi documents or nothing at all, a transaction processing needs to be implemented on top of the replicated shards discussed above. Thus, to implement transactions, a special kind of repository may be used, which may be called a transaction log.

Transactions for which all of the underlying operations have completed and have been written to the transaction log, may receive their own unique identification numbers that are assigned by the first node to acknowledge storing the data from the transaction context into the transaction log and may consist of the identifier of the node that first acknowledges storing the transaction log entry and a sequence number representing the number of transaction log entries labeled by that node for the particular transaction log. Such a number may be assigned by the system in order to keep track of transactions written to the transaction log similarly as to how the system keeps track of documents and their modifications.

Because transactions which are written to the transaction log receive a unique identification number, a virtual timeline of operations and transactions may be stored by the system. A user could then query any particular time to see the state of the transactions and thus the nodes and shard replicas, at any time. This is achieved by passing a transaction log version, and the effect of this is that only the results of committed transactions that have been written to the transaction log up to the specified multi-dimensional version will be included. Also when a new transaction is created by the hub a transaction log version is assigned to it which effectively defines which results of other transactions the transaction will see.

Transaction Log and Transaction Context Examples

It should be noted that the transaction log itself may also be replicated for availability and fault tolerance, just as other pieces of data are as described here. Also, a separate transaction log should exist for each set of data repositories among which multi-document transactions are possible.

There are several possible implementation choices with regard to database system handling several repositories within the same deployment. On one end of the scale it is possible for each repository to have its own transaction log. In such examples, the system may not be able to perform multi-document transactions if those operations operate on multiple repositories. On the other end of scale it is possible to have one shared transaction log for all of the repositories. In such examples, it may be possible to perform multi-document transactions among many repositories. Toward the middle of the scale the repositories that share a transaction log can be grouped by the entity that uses them, namespace or any other convention.

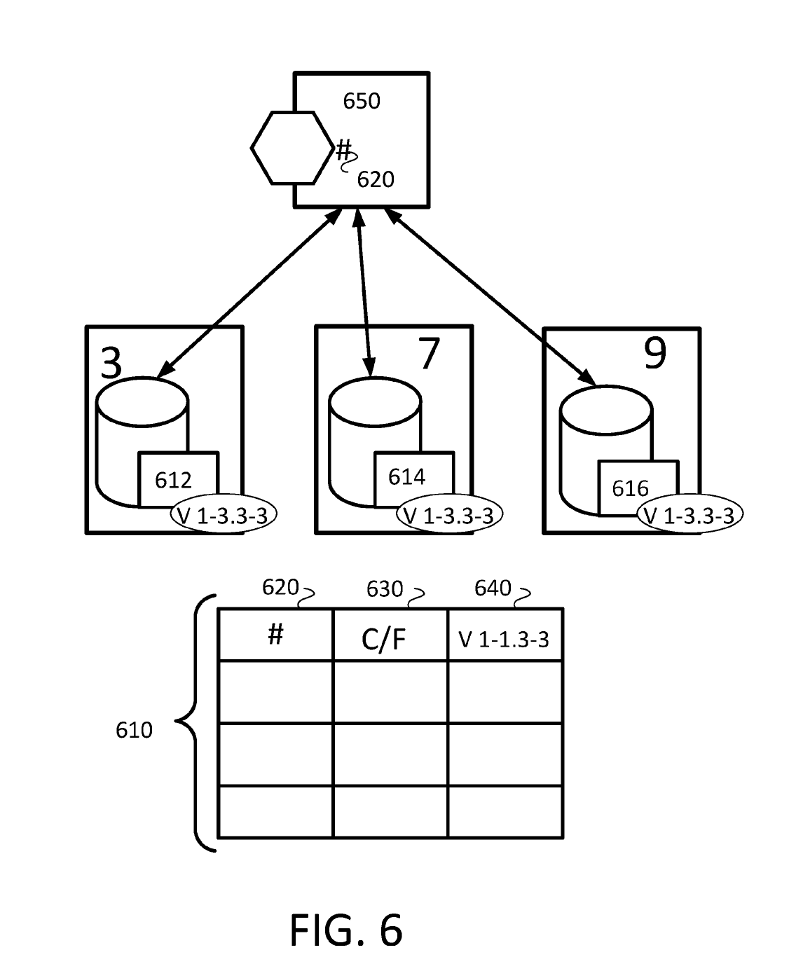

FIG. 6 shows an example transaction log 610 and how the system may use the transaction log to ensure that each replica of the same shard is up to date with the latest documents. Further, such a transaction log may be used to propagate the information about the transaction outcomes and shard versions required to observe their results to the various nodes containing shard replicas. The mechanism for advancing the information stored in the shards and nodes with respect to transaction log shard versions may be called propagation. This process is done for each transaction log by some hub 650 or a set of hubs.

In such examples, the transaction log 610 may store any of various information. The information stored in the transaction log may be considered the transaction log entries. Such transaction log entries may contain any of various categories of information which can be used by the system for propagation of updates and for retrieval and queries and may contain some subset or all of the information that was maintained by the hubs during the execution of the transaction in the transaction context.

For example, in FIG. 6, the transaction log 610 includes transaction log entry that includes information for each transaction token 620, that transaction's outcome, whether committed or failed, 630 and the minimum shard multi-dimension versions (shard version) 640 required to see all of the data created or updated within that particular transaction. In other words for each shard that contains documents modified by the transaction a multi dimension version that includes all of the modifications and additions is stored. In certain examples, the transactions which were not committed may not need to be written to the transaction log.

After a transaction log entry is written it may be used to inform the relevant shard replicas about the outcome of the transaction. This is because the data created or modified may be marked as “uncommitted” in the node that stores the shard replicas. Only once the node is informed about the successful write of the transaction into the transaction log, the data may be marked “committed.”

For each transaction log 610 one or more of the hubs 650 may be assigned to perform the discovery and propagation of that shard version 640 to ensure that the shard replicas are up to date with the transaction outcomes and can release the corresponding locks. In some examples all of the shard replicas will be up to date, in some examples only some will be up to date and in some examples none will be up to date. The hub may then use the updated transaction log 610 to check on the shard replicas and see which need to be updated.

As new documents are stored at any given rate, even many multiple documents in a short time, these nodes and shards may need constant updating and checking. In such examples, the transaction log 610 will be constantly changing and the nodes and shards will need constant updating.

And as a system may have many multiple hubs, in certain examples, when a particular hub discovers that some fraction of the shard replicas need updating, that hub may send this information to some other hubs or attempt to update the nodes by fetching the missing data from the transaction log and sending it to the nodes. Such a propagate transaction log message which may be sent by a hub may include the minimum and maximum transaction log version included in the propagate message. For efficiency only the transaction log entries that affect a given replica between the minimum and the maximum may be included in the message sent to each replica.

Transaction Logs and Sequential Updates

A multi-dimensional version of a transaction log is similar to the shard version described above. Because of this, a hub, a user or client may be able to pinpoint a particular set of committed transactions whose results it wants to observe.

The discovery is a process of discovering a transaction log version for which a sufficient fraction of shard replicas for each shard have seen all of the data and all of the transaction outcomes. The discovered transaction log version is then given to any new transactions as the timeline up to which they see the results of other transactions. A hub may inform other hubs if it has discovered a new version.

The propagate transaction log message which may be sent by a hub during propagation may include the minimum and maximum transaction log version included in the propagate message along with the relevant transaction outcomes and shard versions required to see the data modified by each transaction. The propagation is a process of sending to nodes the transaction outcomes they may not have yet seen by including some range of transaction log entries. For example a propagate message that begins at transaction log version 1-10.2-5 and ends at 1-12.2-7 will include the transaction log entries with identifiers 1-11, 1-12, 2-6, 2-7, the entries may be sorted such that 2-6 is always before 2-7 and 1-11 is always before 1-12. For efficiency, only entries that affect a given shard replica along with the required shard versions should be included in the message sent to each shard replica.

After a node has processed such an update message, if its transaction log version is at least equal to the minimum version included in the propagate message, then it can advance it's transaction log version up to the version of the transaction outcome that it was able to process, because it has all the shard versions 640. If it was able to process all of the outcomes, then it can advance its transaction log version for that shard replica to the maximum version specified in the propagate message (the version 1-12.2-7 in the example above). Also as the node processes the transaction outcomes it may release the locks acquired by the transactions, because it knows that the transactions have completed.

In certain examples, for a sufficiently large transaction number, the transaction log itself may become a bottleneck. This may be because for each committed transaction, some data must be written to all of the transaction log replicas. Then, to increase the transaction processing capability, the transaction log can be replaced by a set of “L” logs. The variable “L” can be chosen arbitrarily high to limit the number of transaction log entries written per second to each of the logs.

In this case, a transaction commit/rollback record can be written to any of the L logs. Also, there may be some hub(s) or processes(s) that do discovery/propagation for each of the L logs. Also, each shard replica may need to keep track of L transaction log versions instead of just one.

In certain examples, it may also be possible to encode L multi-dimension transaction log versions into a single multi-dimension version, for example, by adding a large offset 1000000*L to node ids of version L. This way the node implementation does not need to be modified as long as the encoding decoding of the versions is done at the hub.

Also, in some examples, the transaction contexts and transaction log entries need to keep track of L versions instead of one. In some examples, this can also be encoded into a single multi-dimension version.

The transactions that were not committed may not need to be written to the log. In such examples, all log entries are committed. In some examples all transactions may be written to the log with an indicator as to whether it was committed or failed.

After a transaction log entry is written it is needed to inform the relevant shard replica dimensions about the outcome of the transaction because up to now the data written may be marked as uncommitted. The hub may also send the information written to the transaction log entry to the affected nodes, before the propagation process. The hub may skip writing the transaction log entry to the transaction log altogether and just send the data from the transaction log entry to the affected shard replicas for the transactions that have been aborted or rolled back if such transactions are not written to the transaction log at all. The nodes may need to keep such messages in a separate backlog for processing when they have received all of the document modifications performed by a particular transaction.

Locking Examples

In order to avoid several transactions modifying the same data, locks can be used in certain examples. Locks may act as a way to ensure that the system is modifying what it thinks it is modifying and avoids potential clashes of two operations being performed on the same document at the same time.

In certain examples, the hub may receive a modification request to a certain document. The hub may then attempt to contact all of the nodes and shards in which that particular document is stored and replicated. The hub may then send a lock request to lock that document for the duration of the modification. If, in certain examples, the hub is able to receive an indication that it has secured a lock on the majority of the shards and/or nodes in which this document is stored, then the modification may take place. If, on the other hand, the hub receives an indication that a majority of the shards and/or nodes which have stored the document are not locked, then the transaction will fail. In such a way, the system may be able to help safeguard against simultaneous modifications.

In certain example embodiments, the locks may have some predefined timeout. Such a timeout could be used to prevent a malicious transaction from locking data for too long or to recover in the case that the nodes have not received a message about a transaction failing.

For example, referring to the example of FIG. 6, if the hub 650 receives a modification for a document stored in all three nodes, node 3, 7 and 9, then it will send a lock request to all three. If at least two of the nodes respond that they have secured a lock on the document, then the transaction modification of that document may proceed. If only one or none of the nodes responds that the lock was successfully secured, the system may fail the transaction in the event that the locks were not secured because those documents were already being modified by another transaction. In such an example, the transaction would fail. It would then be up to the client to retry the transaction again.

The example of requiring a majority of the nodes to secure a lock is merely exemplary. It may be that all of the nodes may be required to secure a lock, or some other percentage. The example of a simple majority is intended to be merely illustrative.

Only if for each document added or modified by the transaction the system was able to acquire locks from a majority of shard replicas that store that document and the user has asked to commit or rollback the transaction (or it was rolled back automatically due to some error), the hub may write the transaction log entry into the transaction log. Then the system may propagate the transaction outcome, the documents and/or modifications on the documents.

And after the transaction is complete, the hub may be asked to signal that the transaction is committed, so the changes implemented in the transaction take effect and the locks removed. To do so, a hub may first try to write the relevant information from the transaction log entry to the transaction log. If this fails then the commit also fails, however, if the record is successfully written then the hub may send the information from the transaction log to the nodes affected so that the locks can be released. In certain examples, the node may not be able to process this message because it has not seen all of the data from the transaction. In such examples, the message should be stored for processing until all relevant data arrives, or the replica can just ignore it and wait until propagation.

To provide better consistency, the hub may wait for the committed changes to be propagated, so that a subsequent transaction will be able to see all of the data was properly modified. In case that the transaction is rolled back, in certain examples, the hub may either write the data to the transaction log and rely on the propagation to disseminate it, or it may send a message to the affected nodes to release the locks, or both.

Operation Identification

In order to ensure that a document was not edited between the time it was last read by a particular hub and the time the hub attempts to modify it, a unique number may be used for comparison purposes. Such a unique number could be the document identifier, or a unique operational identification number assigned by the hub at the document creation or modification time, so that each document revision has a globally unique operation identifier. In such examples, the assigned operation identifier may be returned along with each of the document retrieved or returned by a search in the transaction.

Thus, when the hub fetches a document from a node within a transaction, it may note the document identifier or the operation identifier along with the document key, in the transaction context and when the transaction returns to edit or modify or update the document with the same document key, it may pass the required document revision to the node during acquisition of the lock. The node will only issue the lock if the document has not been modified in between, since then the system knows that no alterations were made to the document between the read and modify times. If they do not match, then the document has been altered and the lock is denied for the document, which causes the transaction to fail. In some examples, the request to modify a document may not care whether the document was edited or updated previously, and may go forward with the modification even though the document had been edited.

If a search is done outside a transaction, a discovered transaction log version may be used to ensure transactional consistency of the data. This may be equivalent to starting a transaction, performing a search and then aborting the transaction.

Also, in certain examples, each search request sent to replicas may include a transaction identifier so that uncommitted results of other transactions can be excluded, and uncommitted results of the same transaction can be included.

Propagation of Transaction Log

In certain examples, nodes may receive document modifications from hubs, and in doing so, sequential document identifiers may progress and the system may synchronize the document storage based on those unique identifiers. Nodes may also receive propagate messages from hubs or other processes that contain a subset of transaction log along with minimum and maximum transaction log version included. This allows nodes to learn the outcome of transactions and know which data needs to be marked as committed and which can be safely discarded. It is important that nodes are in sync not only with respect to the data modified by the transactions but that they are also in sync with respect to knowing the outcome of transactions, this is achieved through transaction log propagation.

Each shard replica keeps track of the latest transaction log versions which indicate that it has seen all the document updates and transaction outcomes as committed or failed from the corresponding transaction log up to that version.

In some examples, each node may find out about transaction outcomes from the hubs. In some examples, the node may query the transaction log in order to receive the latest updates. In some examples, a hub or set of hubs may read the transaction log and send chunks of transaction logs to nodes that are not up to date, in order to inform the nodes of the latest updates. Nodes that receive chunks of transaction logs from a hub, may already have seen some but maybe not all of the updates. The node may then use the new and unseen transaction log entries to process, update and then advance its state up to the transaction log version including all the new committed transactions but only if it has already seen all of the data created, deleted or modified by those transactions. If it has not seen all of the data required then the node may be required to wait until the data will be synchronized first before it can advance its transaction log version.

When node processes a search or retrieve operation with a given transaction log version as a baseline it needs to check that it has processed all of the transaction outcomes up to that version which is done by comparing the baseline with the transaction log version up to which the node is up to date. If the node is not up to date with the baseline requested then it cannot process the request and the hub may query some other replica instead.

In some examples, another function of a hub may be to periodically ping nodes to see which nodes have transaction log versions that are up to date. And to discover up to which transaction log version some fraction of all shards are up to date. If a new version is discovered it may be transmitted to other hubs. The version discovered may then be used as a baseline for performing some of the operations outside of transactions such as search and retrieve to ensure transactional consistency. The version discovered may also be stored in the transaction contexts of new transactions created denoting the baseline of data that the new transactions will observe.

Example Computing Device

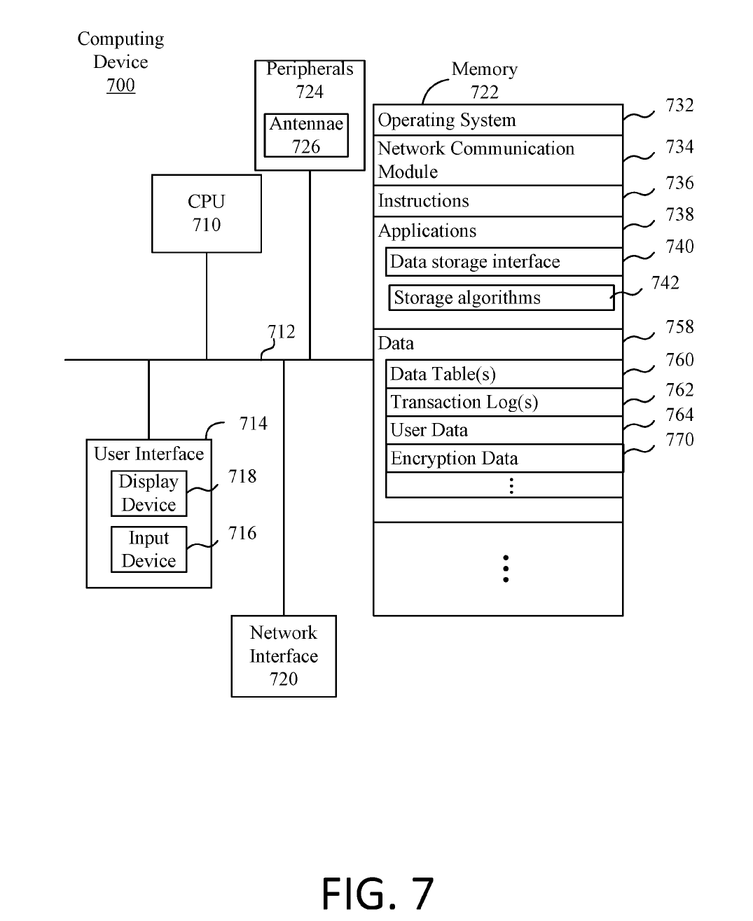

FIG. 7 shows an example computing device 700 that may be used in practicing certain example embodiments described herein. In FIG. 7, the computing device could be a server computer, mainframe, networked computer, distributed computer, desktop, laptop, smartphone, tablet computer, or any other kind of computing device. The example shows a processor CPU 710 which could be any number of processors in communication via a bus 712 or other communication with a user interface 714. The user interface 714 could include any number of display devices 718 such as a screen. The user interface also includes an input such as a touchscreen, keyboard, mouse, pointer, buttons or other input devices. Also included is a network interface 720 which may be used to interface with any wireless or wired network in order to transmit and receive data. The example computing device 700 also shows peripherals 724 which could include any number of other additional features such as but not limited to an antennae 726 for communicating wirelessly such as over cellular, WiFi, NFC, Bluetooth, infrared, or any combination of these or other wireless communications. The computing device 700 also includes a memory 722 which includes any number of operations executable by the processor 710. The memory in FIG. 7 shows an operating system 732, network communication module 734, instructions for other tasks 738 and applications 738 such as data storage interface 740 and/or storage algorithms 742. Also included in the example is for data storage 758. Such data storage may include data tables 760, transaction logs 762, user data 764 and/or encryption data 770.

### CONCLUSION

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 1PROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A non-transitory computer-readable storage medium comprising computer-executable instructions for storing and organizing computer data, the computer-executable instructions comprising instructions to:
store one or more data shards of document repositories, by a hub in communication with a plurality of storage nodes,
receive, by the hub, a data document for storage;
identify, by the hub, a data shard to store the document;
identify, by the hub, nodes where replicas of the identified data shard are stored;
send, by the hub, the document to one of the identified nodes which has stored the identified data shard;
receive, by the hub, a document identifier from the node for the sent document,
wherein the document identifier includes an indicator of the node which stores the identified data shard and a sequential number representing the next sequential number of documents stored in that identified data shard,
wherein the received document identifier also includes an identified data shard indicator; and
send, by the hub, the document to the identified nodes where the replicas of the identified data shard are stored, including the document identifier for the document.

2. The non-transitory computer-readable storage medium of claim 1 wherein the hub is configured to communicate with another hub and the plurality of storage nodes.

3. The non-transitory computer-readable storage medium of claim 1 wherein the shard replicas retain the document identifier of the received document to indicate which documents are stored in the shard replica.

4. The non-transitory computer-readable storage medium of claim 3 wherein the document identifier of the received document is combined with previously received documents to indicate which documents are stored in the shard replica.

5. The non-transitory computer-readable storage medium of claim 1 wherein the hub includes a transaction log which stores information for each transaction, a transaction identifier, a committed status of the transaction and a multi-dimensional shard identifier indicating the documents needed to complete the transaction.

6. The non-transitory computer-readable storage medium of claim 1 further comprising, a client in communication with the hub, the client configured to send the hub a document.

7. The non-transitory computer-readable storage medium of claim 1 further comprising another hub in communication with the plurality of storage nodes.

8. The non-transitory computer-readable storage medium of claim 3 wherein documents received by the node out of sequence are stored in a back log.

9. The non-transitory computer-readable storage medium of claim 8 wherein documents placed in the back log are later stored if any missing sequential documents are received, and
wherein the document identifier is updated when the missing sequential documents are received and stored along with the documents placed in the back log.

10. A system for database management comprising,
a server with a processor and memory, running a distributed architecture of database hubs and nodes, the server configured to,
receive a data document for storage;
send the data document to the hub for storage;
the hubs configured to,
receive document for storage;
identify a shard to store the document;
identify the nodes which store the identified shard and its shard replicas;
select one of the nodes which store the identified shard and its replicas;
send the received document to the selected node;
receive an acknowledgement from the node that the node has received the document for storage and assigned a document identifier to the document; and
send the document and the assigned document identifier to the nodes which store the shard replicas.

11. The system of claim 10 wherein the hubs are further configured to receive a transaction and a respective transaction identifier from the server, the transaction being a series of operations for data documents.

12. The system of claim 11 wherein the hubs are further configured to utilize a transaction log which includes information regarding the received transaction identifier, a committed status of the transaction and a multi-dimensional shard identifier, indicating the documents needed to complete the transaction.

13. The system of claim 10 further comprising another hub in communication with the plurality of storage nodes.

14. The system of claim 10 wherein the shard replicas retain the document identifier of the received document to indicate which documents are stored in the shard replica.

15. The system of claim 14 wherein documents received by the node out of sequence are stored in a back log.

16. The system of claim 15 wherein documents placed in the back log are later stored if any missing sequential documents are received, and
wherein the document identifier is updated when the missing sequential documents are received and stored along with the documents placed in the back log.

17. A method for database management comprising,
by a server with a processor and memory, running a distributed architecture of database hubs and nodes,
receiving a data document for storage;
sending the data document to the hub for storage;
receiving by the hubs, a document for storage;
identifying by the hubs, a shard to store the document;
identifying by the hubs, the nodes which store the identified shard and its shard replicas;
selecting by the hubs, one of the nodes which store the identified shard and its replicas;
sending by the hubs, the received document to the selected node;
receiving by the hubs, an acknowledgement from the node that the node has received the document for storage and assigned a document identifier to the document; and
sending by the hubs, the document and the assigned document identifier to the nodes which store the shard replicas.

18. The method of claim 17 wherein the hubs are further configured to receive a transaction and a respective transaction identifier from the server, the transaction being a series of operations for data documents.

19. The method of claim 18 wherein the hubs are further configured to utilize a transaction log which includes information regarding the received transaction identifier, a committed status of the transaction and a multi-dimensional shard identifier, indicating the documents needed to complete the transaction.

20. The method of claim 17 further comprising another hub in communication with the plurality of storage nodes.
